(19) United States
(12) Patent Application Publication
(10) Pub. No.: US 2025/0331526 A1
(43) Pub. Date: Oct. 30, 2025

(54) METHOD, DEVICE AND SYSTEM FOR MEASURING A POULTRY SLAUGHTER PRODUCT

(71) Applicant: Marel Poultry B.V., Av Boxmeer (NL)

(72) Inventors: Sjoerd Panhuis, Av Boxmeer (NL); Ties Antoon Henricus Hoenselaar, Av Boxmeer (NL)

(73) Assignee: Marel Poultry B.V., Av Boxmeer (NL)

(21) Appl. No.: 18/868,140

(22) PCT Filed: May 24, 2023
(86) PCT No.: PCT/NL2023/050298

§ 371 Date: Nov. 21, 2024

(30) Foreign Application Priority Data
May 30, 2022 (NL) 2032013

(51) Int. Cl. A22C 17/00; A22C 21/00; G01B 11/04; G01B 11/14

(52) U.S. Cl. CPC A22C 17/0073; A22C 21/0053; G01B 11/04; G01B 11/14

(57) ABSTRACT

A method of measuring a poultry slaughter product is disclosed. The method uses a measuring device positioned stationary along a transport trajectory defined by a transport device which has a plurality of successive carriers for holding the slaughter product. The transport device transports the slaughter product held by a carrier of the plurality of successive carriers in a transport direction along the transport trajectory and past the measuring device. The method includes using a contactless distance meter of the measuring device to measure distances between the distance meter and the slaughter product at at least three different locations on the slaughter product. A parameter of the slaughter product is then determined from the measured distances.

The invention relates to a method of measuring a poultry slaughter product. The invention also relates to a device and system for measuring such a poultry slaughter product. The invention further relates to a computer program and a computer-readable storage medium.

WO2017/188812 A1 relates to a system and method for measuring a shoulder joint position of a carcass part of slaughtered poultry. The shoulder joint is the joint which in living poultry connects the wings to the body of the poultry. The shoulder joint position is an indication of the overall size of the carcass part. Said positions are measured by a mechanical contact member engaging the shoulder joints.

Although the known system and method function satisfactorily in practice, they can be further improved.

Therefore, it is an object of the present invention to provide an improved method, device and system for measuring a poultry slaughter product. Therefore, it is another object of the present invention to provide a method, device and system for measuring a poultry slaughter product held by a carrier of a transport device, having less restraints regarding the orientation of the poultry slaughter product during measuring. It is another object of the present invention to provide a method, device and system for measuring a poultry slaughter product, in which the measuring is performed in a more hygienic manner. It is a further object of the present invention to provide a method, device and system for measuring a poultry slaughter product, in which the measurement data are such that they can be used for more purposes.

One or more of the objects are achieved by the method and/or device and/or system according to the present invention. The invention provides a method of measuring a poultry slaughter product, using a measuring device positioned stationary along a transport trajectory defined by a transport device which has a plurality of successive carriers each for holding a slaughter product. The transport device, in use, transports the slaughter product held by a carrier of said plurality of successive carriers in a transport direction along the transport trajectory, past the measuring device. The method comprises the steps of:
a) measuring distances, using a contactless distance meter of the measuring device, between the distance meter and the slaughter product, at at least three different locations on the slaughter product; and
b) determining a parameter of the slaughter product from the measured distances of step a).

The invention further provides a device as defined in claim 13 and a system as defined in claim 14.

An effect of the method, device and system according to the invention is that using the contactless distance meter, the parameter of the slaughter product may be determined in an efficient and relatively easy manner. The measurement is also more hygienic as a result of the contactless nature of the measurement. Also, the measured at least three distances can be used for a variety of purposes since using such measurements a contour of the product passing the measuring device may be determined, for example, which may provide information on a size of the product, or on the state or quality of the product, for example. Further, since the measurement is contactless, the exact orientation of the slaughter product during the measurement may be less relevant.

The carriers may for instance be holders, such as so-called cones, for poultry front halves or shackles from which slaughtered poultry is suspended. The carriers may be rotatably provided in such a manner that an orientation of the poultry slaughter product can be changed during the transporting thereof. In an embodiment, the transport device is arranged to let the poultry slaughter product pass the measuring device in a vertical orientation, preferably head-down.

In an embodiment, said step a) of measuring is executed using a laser distance meter. So, the contactless distance meter of the measuring device may be, or at least comprise, a laser distance meter. The laser distance meter may be configured as a point laser meter or as a line laser meter and/or may use a red laser beam, so having a wavelength in the range of 630 nm to 670 nm.

The measured distances at the at least three different locations may be measured successively in time by the contactless distance meter. So, in a related embodiment, said step a) comprises successively measuring said distances at said at least three different locations on the slaughter product as a consequence of the slaughter product passing the measuring device during the transporting by means of the transport device. The contactless distance meter of the measurement device may thus be configured to execute at least three distance measurements successively, on one and the same poultry slaughter product passing the measuring device. As a result of the movement of the slaughter product past the measurement device in combination with the execution of successive measurements, a plurality of measurements lying on the same line may be performed. An amount of measurements on one product may depend on a frequency of the measurements by the measuring device and on a speed of the poultry product passing the measuring device in the transport direction. An amount of measurements on one product may in embodiments thus be in a range of tens up to thousands of measurements. The higher the amount, the more accurate the contour of the product may be measured since any interpolation between two consecutive measurements plays a smaller role in the determined parameter. So, in an embodiment, the transport device may be operatively connected to the control unit of the measuring device, for the purpose of providing carrier speed related information to the control unit. In an embodiment, a carrier speed may be given and set in the control unit, for example in case that such a speed is constant over time.

Alternatively, the at least three distances may be measured at the same time by a contactless distance meter configured to measure at least three different points on the product, such as is the case with a line laser meter.

In an embodiment, step a) may be triggered by a measured distance falling below a predetermined upper distance threshold. In such an embodiment, the measuring device may continuously perform measurements, wherein the upper distance threshold, which may be a distance between the distance meter and some position on the carrier, triggers measurements of step a). The upper distance threshold may further form a base value to which measured distances may be compared for the purpose of determining the parameter.

In an embodiment, for the purpose of step b), the parameter is a size-related parameter relating to a size of the slaughter product. The size-related parameter is preferably related to a cross-sectional area of the slaughter product, preferably parallel to the transport direction. The larger the cross-sectional area, the larger the size. Using such a laser distance meter, the plurality of distances measured forms a highly suitable basis for determining such a size-related parameter related to a cross-sectional area of the slaughter product. Alternatively, the parameter may be a functional parameter such as a quality-related parameter.

In an embodiment, said step b) comprises determining a size-related parameter which at least partly depends on a pre-determined reference parameter relating to a size, preferably relating to a cross-sectional area, of the carrier holding the slaughter product. In such an embodiment, said reference parameter may be subtracted from a mentioned size-related parameter, determined during step b), so that as a result a parameter relating to the size, preferably a cross-sectional area of the poultry slaughter product as such can be determined. Such a pre-determined reference parameter relating to the carrier may have been determined by letting an empty carrier pass the measuring device and performing measurements analogue to the measurements of step a), and determining said pre-determined reference parameter therefrom.

In an embodiment, at least two classes, preferably three or more such as five classes, are defined of consecutive parameter ranges, the method further comprising the step d) of determining to which of said at least two classes the slaughter product belongs, based on the parameter determined according to step b). The classes may represent different sizes, such as including ‘small’, ‘medium’ and ‘large’ of the slaughter product, for example.

This way, a slaughter product which has been subject to the measuring, can be allocated to one of the classes. For example, processing actions such as skinning, cutting and fillet harvesting, can then be tuned to the different classes so as to improve a quality, or effectiveness, of the processing actions.

In an embodiment, step a) is executed using a plurality, preferably two or three, of said contactless distance meters, preferably laser distance meters, preferably wherein each of the plurality of contactless distance meters is oriented under a different angle, relative to the transport direction, with respect to the slaughter product. In an embodiment, step a) 10 is executed using at least two laser distance meters, a first of the at least two laser distance meters being oriented under an angle having a component in the transport direction while a second of the at least two laser distance meters being oriented under an angle having a component opposite to the transport direction. This may improve an accuracy of the measurements, or, in other words, of the determined parameter.

In an embodiment, the measuring device is positioned along the transport trajectory upstream of a processing device, wherein a downstream measuring device is positioned along the transport trajectory downstream of the processing device, the method comprising the further steps of:
al) measuring distances, using a downstream contactless distance meter of the downstream measuring device, between the downstream distance meter and the slaughter product, at at least three different locations on the slaughter product, preferably the same locations as for the purpose of step a);
b1) determining a parameter of the slaughter product from the measured distances of step a1); the method further comprising the step:
c) determining a quality-related parameter of the slaughter product relating to the execution of a processing action on the slaughter product by the processing device, which quality-related parameter at least partly depends on the respective parameters determined in step b) and in step b1).

By doing so, it may be determined whether the execution of a processing action by the processing device, has been performed as expected, or, in other words, whether a quality-related criterium has been met, for example. It may also be determined whether a carrier-related property, such as a possible rotation of the carrier during processing, functions as expected.

Optionally, the quality-related parameter of said step c) is determined at least partly based on a pre-determined reference quality parameter relating to the execution of the processing action on the slaughter product by the processing device. Said pre-determined reference quality parameter may have been correlated to an associated size-related parameter range. The parameters of steps b) and b1) may be size-related parameters. The parameters of steps b) and b1) may be related to a contour shape of the slaughter product.

In an embodiment, a plurality of product processing actions, such as cutting and deskinning, are defined wherein each of said actions is allocated to an associated size-related parameter range, the method further comprising the step of determining to which of said plurality of product processing actions the slaughter product belongs, based on the parameter determined according to step b). This way it may be determined whether a specific action has been correctly performed, or, whether it has been performed at all, for example.

In an embodiment, the method further comprises setting at least one processing parameter of a processing device upstream or downstream of the measuring device based on the parameter determined during step b). This way, one or more settings of the processing device may be pre-adjusted so that a more optimal processing action may be performed, or such a setting may be adjusted when it is determined downstream that a quality-related parameter relating to the processing action of the processing device falls below some threshold, for example.

The invention also relates to a measuring device for measuring a poultry slaughter product, wherein, during use, the measuring device is positioned stationary along a transport trajectory defined by a transport device which has a plurality of successive carriers each for holding a slaughter product, the transport device in use transporting the slaughter product held by a carrier of said plurality of successive carriers in a transport direction along the transport trajectory, past the measuring device, the measuring device comprising a control unit arranged for:
a) measuring distances, using a contactless distance meter of the measuring device, between the distance meter and the slaughter product, at at least three different locations on the slaughter product;
b) determining a parameter of the slaughter product from said measured distances.

Further, the invention relates to a system for measuring a poultry slaughter product, comprising:
a transport device which has a plurality of successive carriers each for holding a slaughter product, the transport device in use transporting the slaughter product held by a carrier of said plurality of successive carriers in a transport direction along a transport trajectory defined by the transport device; and
a measuring device, according to the invention as described above, for measuring a poultry slaughter product, wherein the measuring device is positioned stationary along the transport trajectory such that the slaughter product held by the carrier is transported past the measuring device;
the measuring device comprising a control unit arranged for:
a) measuring distances, using a contactless distance meter of the measuring device, between the distance meter and the slaughter product, at at least three different locations on the slaughter product; and
b) determining a parameter of the slaughter product from said measured distances.

In respective embodiments of the device and system according to the invention, the control unit is arranged for executing the method according to the invention as described above.

Effects of the measuring device and system are the same or at least similar to the effects described above in relation to the method according to the invention. Embodiments of the method according to the invention apply in an analogous manner to the device and system according to the invention, and vice versa.

The invention also relates to a computer program having instructions configured to, when executed, preferably by a computer of the device, cause a device for measuring a poultry slaughter product, preferably a device according to the invention, to perform the method according to the invention.

Finally, the invention relates to a computer-readable storage medium comprising the computer program according to the invention.

Effects of the storage medium and computer program, when executed, are the same or at least similar to the effects described above in relation to the method according to the invention.

The present invention is described hereinafter with reference to the accompanying highly schematic figures in which embodiments of the present invention are shown and in which like reference numbers indicate the same or similar elements.

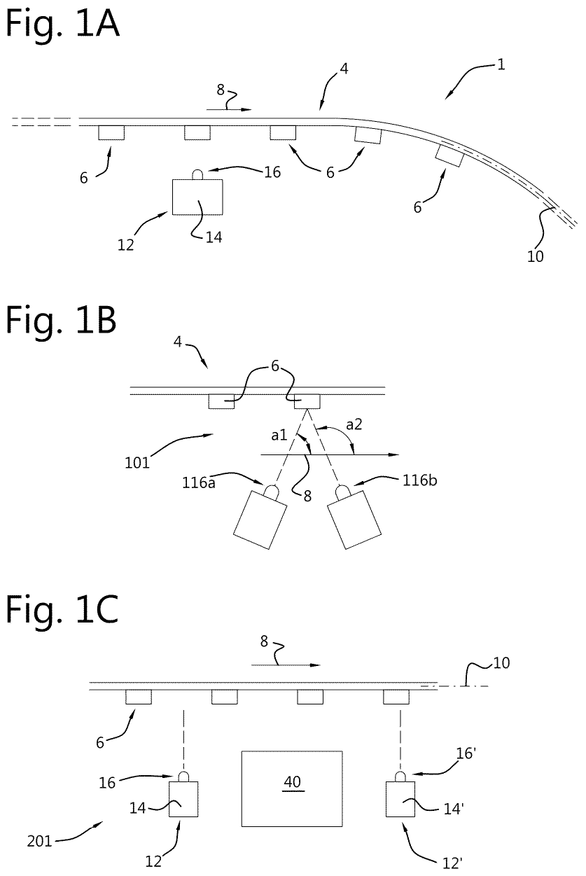

FIG. 1A shows, in top view, an embodiment of a measuring system according to the invention;

FIG. 1B shows an a further embodiment of a measuring system according to the invention;

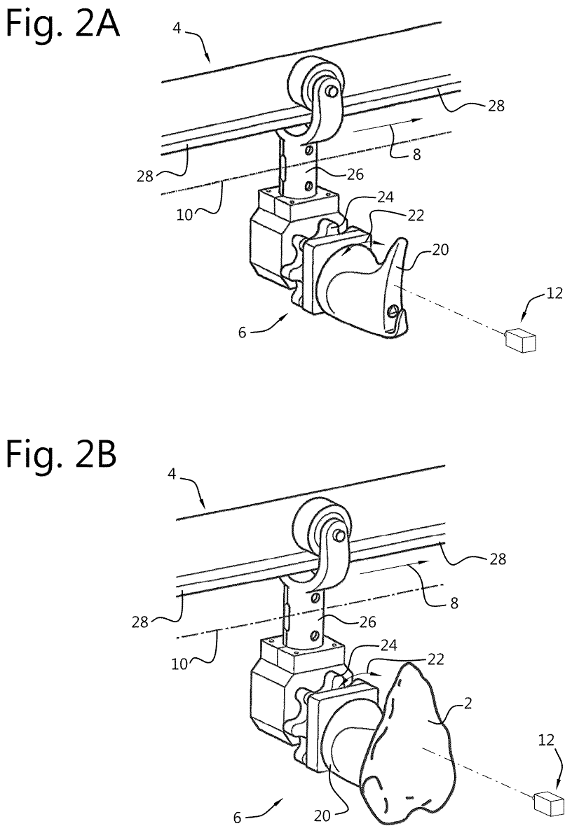

FIG. 1C shows a still further embodiment of a measuring system according to the invention; FIG. 2A shows a part of the measuring system of FIG. 1A in more detail, in 3-dimensional view;

FIG. 2B shows a part of the measuring system of FIG. 1A in more detail, in 3-dimensional view, in which a poultry slaughter product has been provided on a carrier of the system;

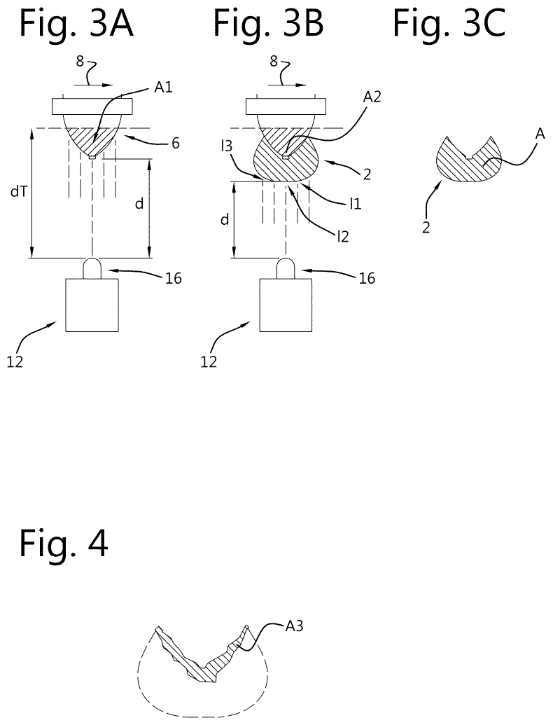

FIG. 3A represents distance measurements on an empty carrier of the system of FIG. 1A;

FIG. 3B represents distance measurements on a carrier of the system of FIG. 1A, the carrier holding a poultry slaughter product;

FIG. 3C represents a cross-sectional area of the poultry slaughter product as such;

FIG. 4 represents a cross-sectional area of the poultry slaughter product as such in a different state thereof in comparison with FIGS. 3B and 3C; and

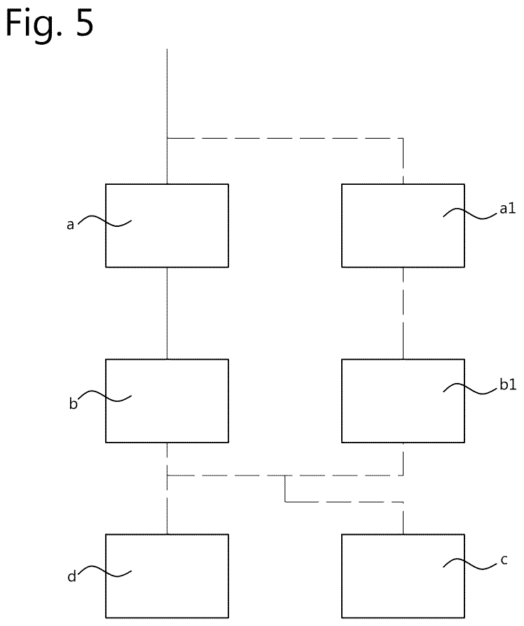

FIG. 5 shows a flowchart of embodiments of methods according to the invention.

FIG. 1A shows a system 1 for measuring a poultry slaughter product 2. In the example shown, the product 2 is a front halve of which the wings have already been removed. The system 1 comprises a transport device 4 which, as common in poultry slaughter product processing, has a plurality of successive carriers 6 each for holding a slaughter product 2 as FIGS. 2A and 2B show. The carriers 6 are shown in FIG. 1A only very schematically. The successive carriers may be driven by a transport chain. The transport device 4 transports the slaughter products 2 each held by one of the successive carriers 6 in a transport direction 8 along a transport trajectory 10 defined by the transport device 4. The system also comprises a measuring device 12, for measuring a poultry slaughter product 2. The measuring device 12 is positioned stationary along the transport trajectory 10 such that the slaughter product 2 held by the carrier 6 is transported past the measuring device 12.

The carriers 6 may each have a poultry product holder body 20 which can be rotated about a horizontal rotation axis, the rotation indicated by reference numeral 22 and the rotation axis being perpendicular to the transport direction 8. Rotation may be imparted by driving the gear wheel 24 with suitable drive means. The carriers 6 further have a supporting arrangement 26 arranged to ride along a rail 28 of the transport device.

The measuring device 12 comprises a control unit 14 arranged for measuring distances d, using a contactless laser distance meter 16 of the measuring device 12, between the distance meter 16 and the slaughter product 2, at at least three different locations 11, 12, 13 on the slaughter product 2. See FIG. 3B, wherein measured distances are represented by the dashed lines. A measurement identified by 12 is just being measured, while a preceding measurement 11 has already been performed, as a consequence of the slaughter product 2 passing the measuring device 12 during the transporting by means of the transport device 4, in the transport direction 8. A subsequent measurement 13 still has to be performed. The laser distance meter 16 is a point laser meter but may a alternatively be a line distanced meter wherein a measuring plane is preferably oriented vertically, that means perpendicular to the transport direction.

The control unit 14 further is arranged for determining a size-related parameter, relating to a size of the slaughter product 2, from said measured respective distances d at the locations 11, 12, 13. The size-related parameter is related to a cross-sectional area A of the slaughter product 2 parallel to the transport direction 8. In practice, much more measurements will be performed on one and the same poultry slaughter product 2. The amount of measurements depends on a frequency of the measurements by the measuring device and on a speed of the poultry product passing the measuring device in the transport direction. The control unit 14 is arranged for executing methods according to the invention as will be described below.

In an alternative system 101 similar to system 1 and shown in FIG. 1B, two of such distance meters 116a, 116b, of respective measuring devices 112a, 112b, are used. The measuring devices 112a and b operate in the same manner as the measuring device 12. The two laser distance meters are oriented under a different angle a1 and a2 respectively, relative to the transport direction 8, with respect to the slaughter product 2. As shown, a first 116a of the two laser distance meters is oriented under an angle al having a component in the transport direction 8 while a second 116b of the at least two laser distance meters is oriented under an angle a2 having a component opposite to the transport direction 8. By doing so, a wider range of view may be obtained which results in a higher measuring accuracy in particular regarding forward facing and rearward facing zones (seen in the transport direction) of the product to be measured.

Embodiments of methods according to the invention, of measuring a poultry slaughter product 2, using a measuring device 12 described above, at least comprise the following steps:
a) measuring distances d, using the contactless distance meter 16 (or 116a, 116b, for example) of the measuring device 12, between the distance meter 16 and the slaughter product 2, at at least three different locations 11, 12, 13 on the slaughter product 2; and
b) determining a parameter A of the slaughter product 2 from the measured distances d of step a).

See also FIG. 5, in which optional method steps have been indicated by the dashed lines.

The measuring device 12 may be arranged to continuously measure distances, which means not only when a carrier passes the measuring device, wherein step a) is triggered by a measured distance d falling below a predetermined upper distance threshold dT. As FIG. 3A shows, the threshold dT may be a distance up to a predefined location on the carrier 6. This way, it may be automatically detected when a carrier passes the measuring device 12 so that measurements in the sense of the above step a) may commence. As mentioned above, the parameter A may be a size-related parameter related to a cross-sectional area of the slaughter product 2 parallel to the transport direction 8.

The step b) comprises determining a size-related parameter which at least partly depends on a pre-determined reference parameter A1 relating to a cross-sectional area, of the carrier 6 holding the slaughter product 2. This is shown in FIG. 3A, where, as a reference measurement, an empty carrier 6 is being measured by the measuring device 12. This means that the size-related parameter A can then be determined by subtracting the parameter A1 from a parameter A2, wherein parameter A2 represents a measurement of a carrier holding a slaughter product 2, as FIG. 3B shows. The parameter A2 thus relates to a cross-sectional area of a combination of the carrier 6 holding the slaughter product 2 and of the product 2 itself. The resulting parameter A, resulting from subtracting A1 from A2, thus relates to a cross-sectional area of the slaughter product 2 as such, as represented in FIG. 3C.

Such determination of the parameter A may in an analogous manner be performed using the above-described system 101.

In an embodiment, the method may further have an optional additional step d), wherein at least two classes C1, C2 are defined of consecutive parameter ranges. During such a step d), it is determined to which of said at least two classes the slaughter product belongs, based on the parameter determined according to step b).

FIG. 1C shows an embodiment of a system according to the invention, having a poultry processing device 40. This may for example be a fillet harvesting device. The measuring device 12 is positioned along the transport trajectory 10 upstream of the processing device 40. The system also has a downstream measuring device 12′ positioned along the transport trajectory 10 downstream of the processing device 40. The device 12′ also has a laser distance meter 16′ and a control unit 14′ and operates in the same manner as the device 12. The method comprises, in addition to steps a) and b) above, the further steps of:
a1) measuring distances d, using the downstream laser distance meter 16′ of the downstream measuring device 12′, between the downstream distance meter 16′ and the slaughter product 2, at at least three different locations on the slaughter product; and
b1) determining a parameter, preferably a mentioned size-related parameter, of the slaughter product from the measured distances of step al).

The latter at least three different locations measured during step al) are preferably the same as those of stap a), or at least measurements at a same vertical height so that a directly comparable cross-sectional area of the poultry slaughter product may be determined in steps b) and b1). The method further comprises the step:
c) determining a quality-related parameter of the slaughter product relating to the execution of a processing action on the slaughter product by the processing device, which quality-related parameter at least partly depends on the respective parameters determined in step b) and in step b1). An example of such a quality-related parameter may be a parameter relating to the presence-or not-of fillets on the poultry slaughter products. After the fillets have been removed using the processing device 40, the cross-sectional shape of the poultry slaughter product will be quite different than before. Such a shape, having the fillets removed, is represented in FIG. 4, its cross-section identified by A3. The outer shape of the product prior to the processing at the processing device is indicated by the dashed line. That shape will thus be measured using the—upstream—measuring device 12. The substantially reduced contour, as a result of the fillet harvesting, will then be measured using the downstream measuring device 12′. This way, it may be determined, for example, whether both fillets have been correctly removed, and/or what must have been the size of the removed fillets, both constituting quality-related parameters.

Optionally, the determination of step c) may also be dependent on a pre-determined reference quality parameter relating to the execution of the processing action on the slaughter product by the processing device. Such pre-determined reference quality parameter may for example be set using a plurality of measurements on products which have also been manually reviewed.

In addition, a parameter determined during step b) may be used as input for a processing parameter of a processing device upstream or downstream of the measuring device. For example, when the parameter indicates that the product at issue is a ‘small’ product, cutters of a downstream cutting processing device may be adjusted for that purpose. When a parameter indicates that fillets are sometimes not completely removed from the carcass of the poultry slaughter product, for example, harvesting tools, such as scrapers, of an upstream processing device may be adjusted after which the parameters as determined for multiple processed products are evaluated again, possibly resulting in another iteration of adjusting some tool of the upstream processing device.

The foregoing description provides embodiments of the invention by way of example only. The scope of the present invention is defined by the appended claims. One or more of the objects of the invention are achieved by the appended claims.

1. A method of measuring a poultry slaughter product using a measuring device positioned stationary along a transport trajectory defined by a transport device which has a plurality of successive carriers each for holding a slaughter product, the transport device in use transporting the slaughter product held by a carrier of said plurality of successive carriers in a transport direction along the transport trajectory and past the measuring device, the method comprising:
measuring one or more first distances, using a contactless distance meter of the measuring device, between the distance meter and the slaughter product, at at least three different locations on the slaughter product; and
determining a first parameter of the slaughter product from the one or more first distances-of step a).

2. The method according to claim 1, wherein the measuring is executed using a laser distance meter.

3. The method according to claim 1, wherein measuring the one or more first distances further comprises:
successively measuring the one or more first distances at said at least three different locations on the slaughter product as a consequence of the slaughter product passing the measuring device during the transporting by the transport device.

4. The method according to claim 1, wherein measuring the one or more first distances is triggered by a measured distance falling below a predetermined upper distance threshold.

5. The method according to claim 1, wherein the first parameter is a size-related parameter relating to a size of the slaughter product.

6. The method according to claim 5, wherein the size-related parameter is related to a cross-sectional area of the slaughter product parallel to the transport direction.

7. The method according to claim 5, wherein
the size-related parameter at least partly depends on a pre-determined reference parameter relating to a cross-sectional area of the carrier holding the slaughter product.

8. The method according to claim 1, further comprising:
defining at least two classes of consecutive first parameter ranges; and
determining to which of said at least two classes the slaughter product belongs, based on the first parameter.

9. The method according to claim 1, wherein measuring the one or more first distances is executed using a plurality of said contactless distance meters, wherein each of the plurality of contactless distance meters is oriented at a different angle relative to the transport direction, with respect to the slaughter product.

10. The method of claim 9, wherein step measuring the one or more first distances is executed using at least two laser distance meters, a first of the at least two laser distance meters being oriented under a first angle having a first component in the transport direction while a second of the at least two laser distance meters being oriented under a second angle having a second component opposite to the transport direction.

11. The method according to claim 1, wherein the measuring device is positioned along the transport trajectory upstream of a first processing device,
wherein a downstream measuring device is positioned along the transport trajectory downstream of the first processing device, the method further comprising:
measuring one or more second distances, using a downstream contactless distance meter of the downstream measuring device, between the downstream distance meter and the slaughter product, at at least three different locations on the slaughter product;
determining a second parameter of the slaughter product from the one or more second distances; and the method further comprising the step:
determining a quality-related parameter of the slaughter product relating to the execution of a processing action on the slaughter product by the first processing device, which quality-related parameter at least partly depends on the first parameter and the second parameter.

12. The method according to claim 1, further comprising:
setting at least one processing parameter of a second processing device disposed upstream or downstream of the measuring device based on the first parameter.

13. A measuring device for measuring a poultry slaughter product, wherein, during use, the measuring device is positioned stationary along a transport trajectory defined by a transport device which has a plurality of successive carriers each for holding a slaughter product, the transport device in use transporting the slaughter product held by a carrier of said plurality of successive carriers in a transport direction along the transport trajectory, past the measuring device,
the measuring device comprising a control unit arranged for:
measuring one or more first distances, using a contactless distance meter of the measuring device, between the distance meter and the slaughter product, at at least three different locations on the slaughter product; and
determining a first parameter of the slaughter product from the one or more first distances.

14. A system for measuring a poultry slaughter product, comprising:
a transport device which has a plurality of successive carriers each for holding a slaughter product, the transport device in use transporting the slaughter product held by a carrier of said plurality of successive carriers in a transport direction along a transport trajectory defined by the transport device; and
a measuring device, for measuring the poultry slaughter product, wherein the measuring device is positioned stationary along the transport trajectory such that the slaughter product held by the carrier is transported past the measuring device;
wherein the measuring device comprises a control unit, and
wherein the control unit of the measuring device comprises:
one or more processors; and
a non-transitory computer-readable memory comprising computer-executable instructions stored thereon that, when executed on the one or more processors, cause the one or more processors to perform:
measuring one or more first distances, using a contactless distance meter of the measuring device, between the distance meter and the slaughter product, at at least three different locations on the slaughter product; and
determining a first parameter of the slaughter product from the one or more first distances.

15. (canceled)

16. (canceled)
